(19) United States
(12) Patent Application Publication
(10) Pub. No.: US 2007/0291123 A1
(43) Pub. Date: Dec. 20, 2007

(54) Remote operated surveillance system

(76) Inventor: Monty Cole, Santa Barbara, CA (US)

Correspondence Address: LAW OFFICES OF ANDREW Y. SCHROEDER, 500 SOUTH BROADWAY, SUITE 222, SANTA MARIA, CA, 93454, US

(21) Appl. No.: 11/453,469

(22) Filed: Jun. 14, 2006

(51) Int. Cl. H04N 5/225

(52) U.S. Cl. 348/207.11

(57) ABSTRACT

A remote surveillance system used for monitoring movements and sounds comprising: a power system, a video system, an audio system, a CPU, a communications system, and a housing; the power system comprising at least one solar collector and at least one battery, the solar collector is in communication with a battery, the video system comprises at least one camera; the communications system comprises a cell transmitter, a cell receiver, the communications system is in communication with the audio and video systems; the audio system comprises at least one microphone, the microphone(s) are located on top of the housing.

### FIELD OF THE INVENTION

The present invention relates to security and military applications and more particularly relates to surveillance systems.

### BACKGROUND OF THE INVENTION

To date, there is no security system or apparatus which is self-contained and which can be remotely-operated for extended periods of time without a connected power source. Most surveillance systems are battery-operated and require frequent battery changes and must be within range of a nearby city such that it would be feasible for a person to continuously change the batteries. This can become problematic if one desires to monitor and secure a parcel of land which is either far away, situated under intemperate climate, or which is dangerous in nature. For instance, if one would like to monitor a particularly violent region without placing himself at risk, he would probably need a system which would have a continuous electrical source. Unfortunately, these regions may not lend themselves to a sustainable and reliable infrastructure.

Another shortcoming with most surveillance systems is the fact that they do not enable a user to operate the camera or audio system to diagnose or discern critical details. For instance, most security systems are not enabled to detect and transmit sound and only focus on visual feeds. And even when the surveillance system does include an audio component, the system usually cannot detect and discern critical information. If a surveillance system cannot discern the difference between an animal and a human, the efficacy of the system is substantially marginalized.

It would be very useful for an audio system to be able to distinguish between gun shots, location of sound, whether the sounds are gun shots or explosions, who is firing the gun shots, whether this poses a threat or is benign, etc. For instance, it would not be expedient for the surveillance system to alert a remote operator or other security person every time a person walks by the surveillance system in the afternoon if it is typical for foot traffic that particular time of day. Or it would likewise not be advisable to alert a person every time a truck passes by if there is a paved road nearby. However, other sounds such as the clicking of a magazine with a gun or the sound of a specific language may prove especially pertinent for security reasons.

Due to these shortcomings one would only have to guess or conjecture as to whether there is a threat and whether to take action. For instance, if the surveillance system hears a loud thunderclap which sounds like an explosion the user may needlessly send personnel to the site when the thunderclap originated from a muffler of an old car. Moreover, other seemingly innocuous sounds which might be ignored or undetected may prove to be critical such as the marching of troops or the furtive reconnaissance of thieves.

Another shortcoming of most surveillance systems is the limited scope of sight. Most surveillance systems only offer a low-grade quality of sight or limited scope of site. Some systems are not enabled for night vision. Other systems possess blind spots or lack the zoom capabilities necessary to determine if there is a real threat. What's more, few systems enable a viewer to focus on a target via remote control.

With respect to military applications, most surveillance systems do not enable the apparatus to react to a threat or target. Most surveillance systems do not possess the ability to emit a laser at a target for the purpose of directing a smart bomb or any other laser-guided ordnance. By the time a threat is detected and aircraft are scrambled out to the site, the opportunity may have long since passed before the threat can be neutralized.

Therefore, what is clearly needed in the art is a proactive and remotely-programmable surveillance system which is self-contained with respect to power supply. In addition, this system should also be enabled with advanced audio surveillance abilities such as detecting specific sound signatures such as gunfire, explosions, troop movements, etc. Moreover, this system should be remotely operated such that a person may be able to zoom in on a target, thus enabling a person to record and analyze the threat potential of this target. In addition, the system should be enabled with an audio system which can amplify sounds in order to match them with various sound signatures in order to provide more granularity of detail with regards to threat assessment. Furthermore, the system should also be able to “light up” a target with a laser in order to guide smart ordnance. And the system should be enabled to amplify and analyze various sounds of interest.

### SUMMARY OF THE INVENTION

It is an object of the present invention to provide a proactive and remotely-programmable surveillance system which is self-contained with a continuous and renewable power supply. In most embodiments, the system will incorporate solar technology to power the system.

It is another object of the present invention to become a “smart” surveillance system. This system will be able to distinguish from sounds which are of particular interest and those sounds which are to be ignored. In some preferred embodiments the system may incorporate a means of analyzing various sound signatures for the purpose of identifying various objects and targets such as gunfire, explosions, troop movements, border patrol, etc.

Moreover, the system should be automated according to various macros. However, there may be an override mode whereby a remote operator may take over the system and operate it against the macros. The remote operator should be able to zoom in on any target for the purpose of recording and analyzing the threat of a potential target or enemy.

In addition, the system should be enabled with an audio system which may amplify sounds in order to match them with various sound signatures in order to provide more granularity of detail with regards to threat assessment.

Furthermore, the system should also be able to “light up” a target with a laser in order to guide smart ordnance in military applications.

And the system should be enabled to amplify and analyze various sounds of interest.

### BRIEF DESCRIPTION OF THE DRAWING FIGURES

FIG. 1a is a cross-sectional view of a preferred embodiment of the present invention.

FIG. 1b is a plan view of a preferred embodiment of the present invention.

FIG. 2a is an block diagram of a preferred embodiment of the present invention.

FIG. 2b is a block diagram of a preferred embodiment of the present invention

FIG. 2c is an block diagram of a preferred embodiment of the present invention.

FIG. 2d is a block diagram of a preferred embodiment of the present invention.

FIG. 2e is a block diagram of a preferred embodiment of the present invention.

FIG. 2f is a block diagram of a preferred embodiment of the present invention

FIG. 2g is a block diagram of a preferred embodiment of the present invention.

FIG. 3 is a perspective view of a preferred embodiment of the present invention.

FIG. 4 is a perspective view of a preferred embodiment of the present invention

FIG. 5 is an perspective view of a preferred embodiment of the present invention.

### DESCRIPTION OF PREFERRED EMBODIMENTS

According to a preferred embodiment of the present invention, a unique system is used for remote-controlled surveillance. The present invention is described in enabling detail below.

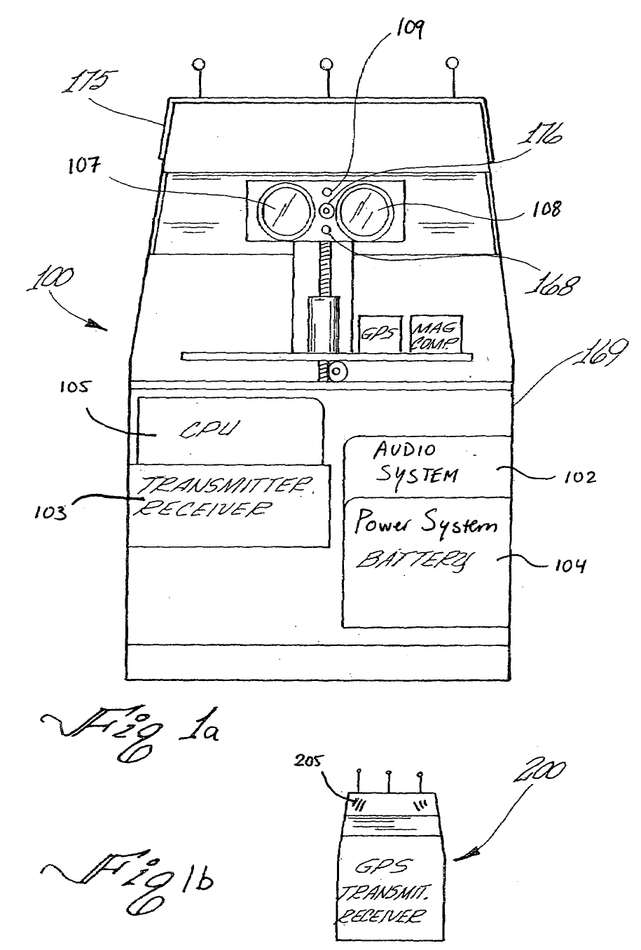

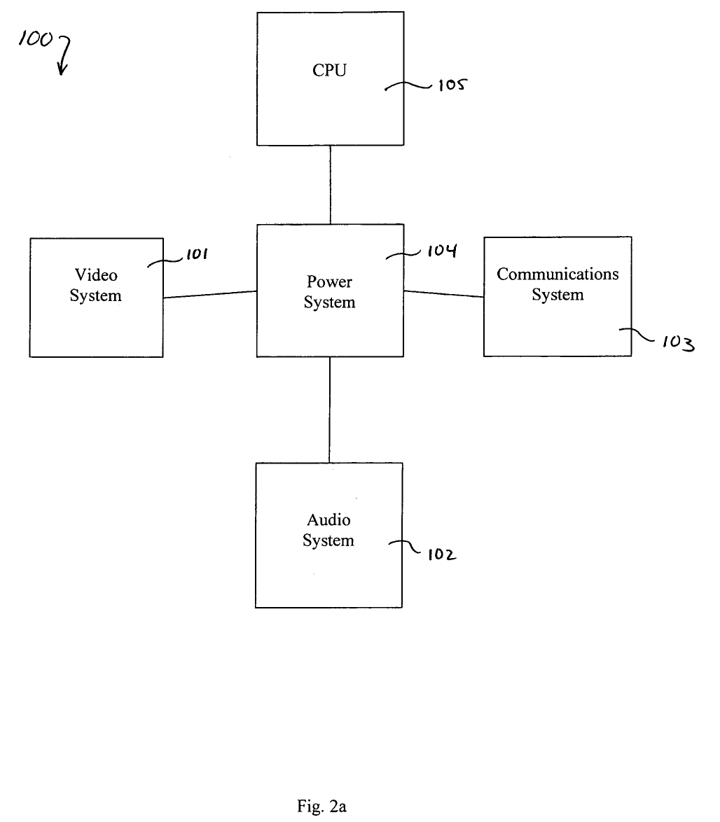

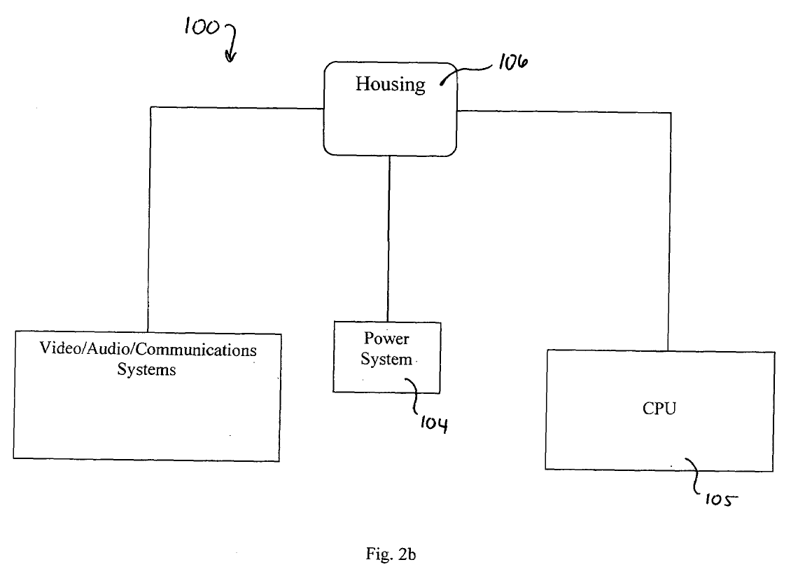

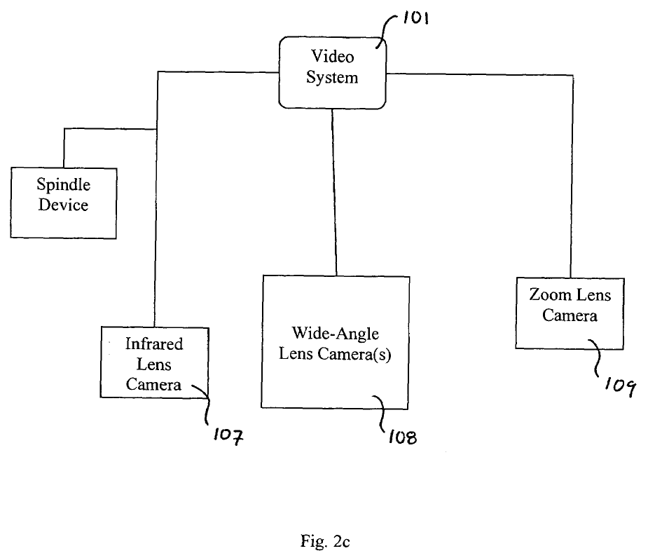

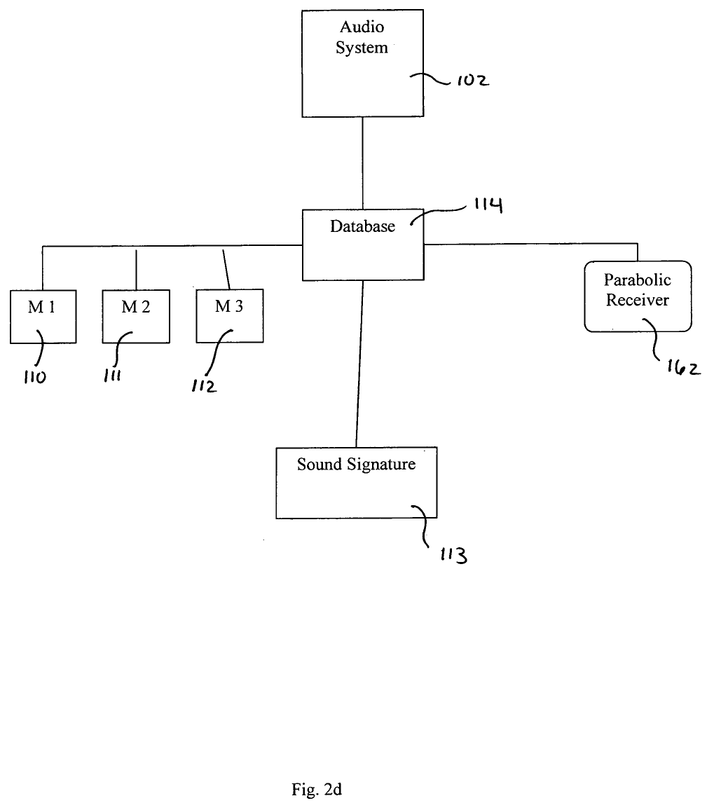

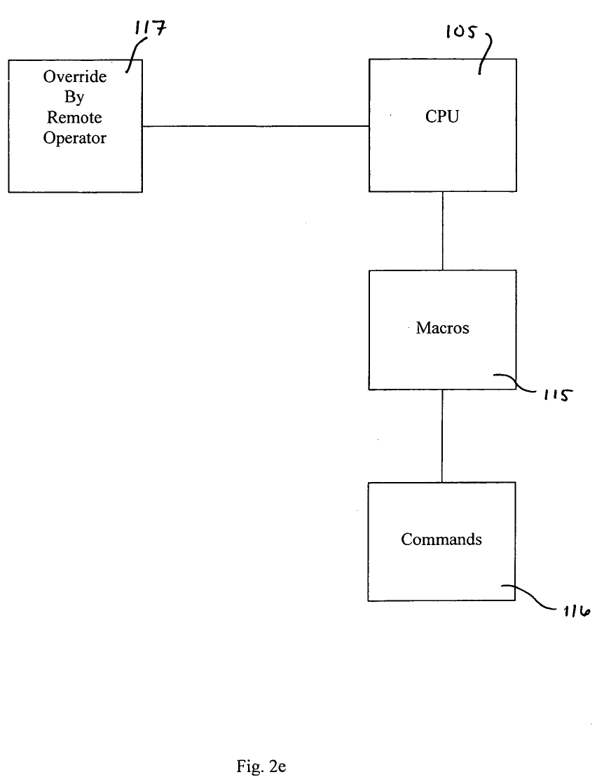

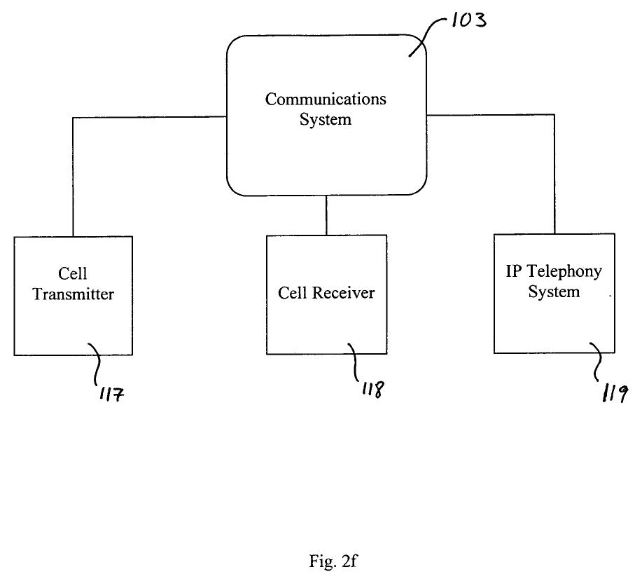

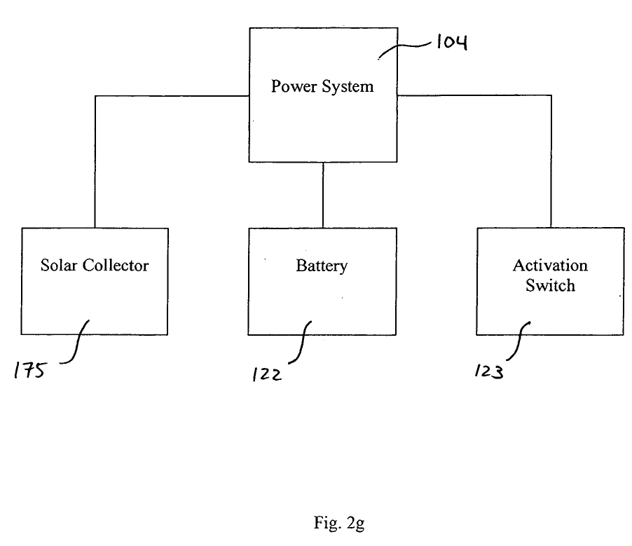

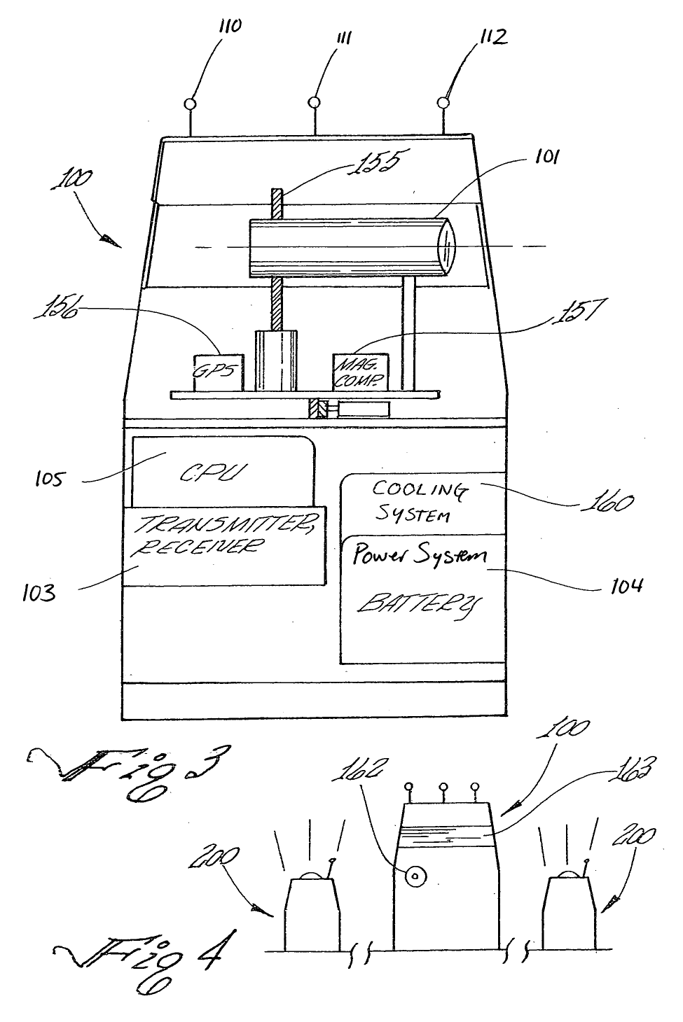

FIG. 1a illustrates a preferred embodiment of the present invention. FIGS. 2a-2g illustrate block diagrams of preferred embodiments of the present invention. Remote Surveillance System 100 (hereafter RSS 100) comprises a video system 101, an audio system 102, a communications system 103, a power system 104, a CPU 105, and a housing 106.

FIG. 2c illustrates one preferred embodiment of the Video system 101 is comprised of three lenses: an infrared lens 107, wide angle lens 108. Video system may also incorporate a spindle apparatus 155 for the purpose of moving the cameras to locate an object. Infrared lens in some embodiments is enabled for zoom-in/out capabilities as well as night vision. The infrared lens is positioned in the anterior hemisphere of the RSS. Both wide angle lenses are positioned on the anterior hemisphere. Although in this particular embodiment there are three sets of cameras it should be understood that other preferred embodiments may only incorporate one of these cameras. In other preferred embodiments, the video system may further incorporate other types of cameras which may prove to be more expedient for the particular assignment for which it will be deployed. For this reason the scope of the present invention should not be limited to the number or type of cameras used.

Although the present invention may incorporate infrared lenses, wide angle lenses, and zoom enabled cameras in some preferred embodiments, the present invention may incorporate other different types of cameras which may be more expedient due to the desired objectives of the purchaser. For instance, if night-vision is not important or necessary because the only concern arises during daylight hours, then another camera may be substituted. In general, many different components may be incorporated in such a way in order to custom-tailor a system to meet specific objectives or parameters of a user. For this reason, the present invention is not intended to be limited in scope as to the particular type of cameras being used.

FIG. 2d illustrates one preferred embodiment of the Audio system 102. Audio system is comprised of at least three microphones: M1 110, M2 111, M3 112, sound signatures 113, a database 114, and a parabolic receiver 162. In some preferred embodiments, the three microphones are positioned on top of the dome of the RSS. In order to enable RSS for directional source triangulation in order to determine the location of the sounds, the three microphones are spaced substantially equidistantly from each other. It should be understood that although in some preferred embodiments there are 3 microphones used for the purpose of triangulation of position of sounds, other preferred embodiments may incorporate more or less microphones. In addition, a panoply of microphones abound which all may prove equally expedient for the purposes of the present invention. For this reason, the scope of the present invention should not be circumscribed by the number or type of microphones used.

Parabolic receiver 162 is used to amplify sounds originating from hundreds of yards away. For instance, if RSS locates 2 people speaking with each other 300 yards away, parabolic receiver can be aimed at the people and transmit or record their conversation. The parabolic receiver can also be used to discern suspicious noises or movements. However, the use of the parabolic receiver is not necessary to practice the present invention. For this reason the scope of the present invention should not be limiting to including a parabolic receiver.

CPU 105 is used in order to enable RSS to discern sound signatures for the purpose of distinguishing between gunfire, explosions, tanks, trucks, troop movements, language detection, model of aircraft, etc. For instance, if RSS picks up a person's voice, the CPU may access database 114 to match the voice with that of hundreds of known languages or dialects. These voices or noises may be compared and contrasted with sound signatures 113. The resulting analyses will enable RSS 100 to discern whether the voice is male or female, country of origin, and specific region by dialect. RSS may also be able to detect how old the person is, relative health of the person, occupation, personality type, etc. With respect to vehicles, RSS may further incorporate algorithms and signatures with increased granularity in order to identify a particular engine of a truck, particularly if it is a 6 cylinder or an 8 cylinder vehicle.

CPU 105 may also be enabled to determine the type of gunfire which is being fired. CPU may be able to detect what caliber of rifle is being used via sound signature analysis. Moreover, in conjunction with the directional triangulation the CPU may be able to determine speed, direction, and provenance of projectiles as well.

Database 114 is accessible to the CPU. Database comprises sound signatures which enable CPU to match a sound with a particular signature to determine the nature of the object or person which is creating the sound. Moreover, database may also be accessible to friendly troops aside from the operator. RSS may be accessible to troops or other parties either through various communication up-links such as the internet or via cell phone. Or, alternatively, the RSS may further incorporate an interface for a person to access database for the purpose of gathering intelligence.

Database may further include a poison pill algorithm in some preferred embodiments. If remote operator or RSS detects it has been stolen or otherwise compromised, RSS may self destruct and destroy all data including all audio and video feed. In addition, RSS may also incorporate various explosive means in order to destroy itself, its technology, as well as injure the enemy.

It should be pointed out here that in some preferred embodiments the sound signature analysis may be performed off-site either at a command station or by another remote computer. Factors which may influence the incorporation of sound signature analysis may include: marketing, price points, climate conditions, etc. For this reason, the sound signature analysis is not intended to limit the scope of the present invention.

FIG. 2e illustrates a very basic software or operational architecture of a preferred embodiment of the present invention. It must be noted here that CPU may incorporate the use of macros 115 which will position the lenses of the cameras. For instance, when the CPU receives a sound, a macro will immediately actuate a series of commands 116. One of those commands may be to triangulate the precise location of the sound. Afterwards, the CPU may calculate the angle of rotation for which the lens must turn in order to acquire the target object within its scope and also how much magnification would be required to bring the object into focus. Consequently, the CPU may actuate camera motor in order to position the camera toward the object. While canvassing the object the CPU may actuate audio feed through the parabolic receptor and transmit feed to the remote operator.

Another point which will be noted here is that although macros will automatically direct camera and other components into pre-determined steps, the remote operator will have the ability to override 117 the RSS and re-direct or re-purpose the components of the RSS as he sees fit. Therefore, macros will contain an override algorithm in order to enable an override by the remote operator.

FIG. 2f illustrates a preferred embodiment where the Communications system 103 comprises cell transmitter 117, a cell receiver 118, and an IP telephony system 118. Cell transmitter, cell receiver, IP telephony system, and computer are all well known in the art and are relatively interchangeable. For purposes of clarity, the IP telephony system may further comprise a computer or other components required for its expedient use.

Just about any of these components may be used for the purposes of the present invention. For instance, microwave transponders may be incorporated into the RSS under expedient factors. Other transponders may also incorporate satellite phones, radio frequencies, etc. For this reason, the present invention should not be construed to being limited to one particular type of transponder. It is of no consequence what type of transponder is incorporated into the present invention inasmuch as it satisfies the prime objectives of the particular operation to which it will be tasked.

FIG. 2g illustrates a preferred embodiment of the present invention where the Power system 104 comprises solar collectors 175, batteries 122, and an Activation Switch 123. Solar collectors are affixed to the dome or side walls of the housing.

It should be pointed out here that the solar collectors are often referred to in the art as photo-voltaic cells, among other terms. The term solar collector refers to any device or apparatus used to convert light into energy. Solar collectors should be enabled to convert either any light into energy whether from the sun or other source.

There abound a vast array of different solar collectors which may all be expedient for use with the present invention. For instance, some solar collectors such as solar cells may be comprised of copper indium diselinide (CuInSe₂). Other solar cells may be comprised of other more common materials. It is of no consequence which type of solar collector is used. For this reason, the present invention is not to be construed as limiting the type of solar collector or solar cell which will be used. Solar collector is in communication with the batteries. Batteries are re-chargeable and collect energy flowing from the solar collectors.

Activation switch 123 acts as the power switch for the RSS. RSS shuts down to sleep mode when the activation switch shuts down due to inactivity. And activation switch activates the RSS when either the audio system or the video system detects either sound or motion. Enabling a motion or sound activation power system allows the RSS to conserve energy in order to effectively ration the power needs throughout the day.

Activation switch 123 may also be controlled by the CPU. In some preferred embodiments the CPU may actuate the activation switch every 10 minutes to take still pictures of the site. These pictures may be transmitted to the remote location and afterwards the RSS will shut down.

Activation switch will be actuated primarily through sounds. Various sounds will activate the RSS and fully power when a certain sound signature matches that of one of the target signatures which it is tasked with monitoring. An example would be if a 10-wheel truck were to come to a stop off to the side of a road. As the brakes screech RSS will immediately turn on and activate the video system to zoom in on the truck, activate the parabolic receiver to gather conversations and relay them to the remote operator.

In some preferred embodiments target signatures may be further incorporated in the CPU in order to activate the RSS from dormant mode to active mode. An example of a target signature may be if a vehicle turns off its lights. The instant this target signature is matched within the database, the RSS will fully activate. However, not all preferred embodiments of the present invention may incorporate target signatures because the target signatures may be maintained at a remote site. Or the target signatures may need to be continuously uploaded or downloaded into and out of the RSS. For this reason the scope of the present invention does not necessarily include target signatures into its database or CPU.

For the purpose of monitoring ambient sounds searching for critical signatures, audio system is comprised of a dormant mode and an active mode. In dormant mode the audio system is still running whereas the rest of the systems (or most of the systems) of the RSS is completely turned off. For instance, the sound signature of a shovel hitting the earth may trigger the RSS to power from dormant mode to active mode if the sound of the shovel is a target signature.

It should be noted here that audio system may need to be programmed to intentionally ignore various innocuous sounds or other sounds which the user expects to hear. For instance, the chirping of birds in most cases would not be interesting to note by a remote operator. However, in other situations the sounds of birds may indicate enemy encroachment into the territory. For this reason, audio system may need to use certain signatures in order to understand and discern what to ignore.

In some preferred embodiments the present invention may further incorporate a Laser system 176 which is used in order to direct laser-guided ordnance to a target. When a remote operator is ordered to neutralize a target, the remote operator will use the video system to locate the target. Thereafter, the laser system 176 is directed to beam a laser at the target. Consequently, a smart bomb or missile will be directed towards this target.

Housing 169 is comprised of a covering which holds the aforementioned systems. In some preferred embodiments the housing may be comprised of a composite polycarbonate material. Although the housing may be comprised of composite polycarbonate material, it should be understood that the housing may comprise a panoply of different materials which may be equally expedient for the objectives of the invention. The type of materials used may be determined in part by the objectives of the RSS and its surrounding environment.

Housing 169 in some preferred embodiments incorporates several vents 205 on the exterior. Vents may be incorporated in virtually any surface of the housing. It would be preferable to incorporate vents on the lower surfaces of the housing and upon the upper portions of the system to facilitate an expedient heat transfer process. The purpose of the vents is to release heat from the system in order to prevent overheating.

Window 163 in some preferred embodiments is located upon the upper dome portion of the housing. This particular window wraps around which enables the cameras to rotate around its axis in order to acquire panoramic vision. This panoramic window also simplifies the RSS system itself. Whereas in some embodiments, the RSS will rotate around in order to aim and focus the lenses, this particular embodiment does not require the whole housing to operate. The advantage of a panoramic window is that it may save power and electricity because only the cameras will need to be rotated instead of the whole apparatus. However, this is not to suggest that the present invention is limited in scope to requiring a panoramic window and a motor only for the purpose of rotating the cameras instead of the housing. Other preferred embodiments may use one or the other, or in some cases, both systems.

Furthermore, in warm climates, the present invention may further incorporate a cooling system 160. The cooling system may be comprised of fans. And in other preferred embodiments, the cooling system may also be equipped with freon in the event that the system is equipped with an air conditioning system.

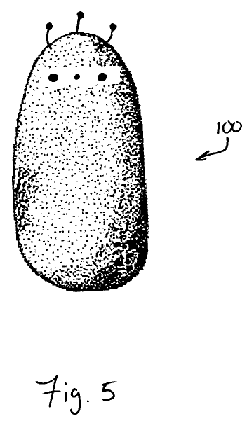

FIG. 5 illustrates a preferred embodiment wherein the may also be made to be camouflaged with the surrounding environment. When the RSS is used in desert climates, the housing may be composed of a lightweight, beige composite material to match the color of the sand and other surrounding vegetation. Housing may also be embodied in irregular shapes in order to appear like a rock. Although the RSS in FIG. 1 is depicted as a cylindrical and upright apparatus, it should be understood that RSS may embody the shape of a dead tree, a rock, or another innocuous figure or shape in order to escape detection.

In addition, in other preferred embodiments the RSS may further incorporate satellites 200 as illustrated in FIG. 2. Satellite 200 in some embodiments may be another RSS. Or in other embodiments the satellite may be any device or apparatus which can monitor the environment. The purpose of the satellite is to widen the scope of the RSS and to give it increased range of surveillance. It may be possible for one RSS to further incorporate hundreds of satellites spread out over several square miles.

When a satellite observe sound or movement, a GPS locator incorporated into the satellite will instantly enable RSS to swivel, locate, and observe what the satellite has noticed. In this instance, it would be preferable for the RSS to be perched on an elevated point in order to observe the RSS with its video system and lenses. Satellites may also incorporate audio and video systems which can also relay information to either or both the RSS and the remote operator. Therefore, the remote operator may be able to receive real time feed on two monitors of two different angles of the object of interest.

In addition, in some preferred embodiments the satellites may emit an infrared light to allow the RSS to view at a distance what the satellite has detected. This infrared light might also be further augmented by also incorporating a laser for use in highlighting the target for the RSS as well as for any smart ordnance which may be directed

However, satellites do not necessarily have to be very complicated. Satellites may be comprised of very inexpensive embodiments which are either motion or sound activated. For this reason, it is of no consequence what type of device or apparatus is used to comprise the satellite inasmuch as it can detect either sound or movement and somehow communicate with RSS, preferably without being detected.

In addition, RSS 100 may also incorporate location devices such as a GPS device 156 and/or a magnetic compass 157. The purpose or function of these devices is to enable the RSS to triangulate positions of various sound-emitting objects as well as enable the user to determine the location of the RSS. These location devices may also be incorporated into the satellites as well. However, the present invention may not necessarily incorporate the location devices in all preferred embodiments. For this reason, it should not be construed that the present invention must incorporate location devices in all embodiments.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A remote surveillance system used for monitoring movements and sounds comprising: a power system, a video system, an audio system, a CPU, a communications system, and a housing; the power system comprising at least one solar collector and at least one battery, the solar collector is in communication with a battery, the video system comprises at least one camera; the communications system comprises a cell transmitter, a cell receiver, the communications system is in communication with the audio and video systems; the audio system comprises at least one microphone, the microphone(s) are located on top of the housing.

2. The remote surveillance system of claim 1 further comprising an infrared camera lens for nighttime surveillance.

3. The remote surveillance system of claim 2 further comprising at least one wide angle lens camera.

4. The remote surveillance system of claim 3 wherein the audio system incorporates at least 3 microphones.

5. The remote surveillance system of claim 4 wherein the audio system is enabled to triangulate the location of sounds.

6. The remote surveillance system of claim 3 further comprising an activation switch, the activation switch is for activating the remote surveillance system or turning off the remote surveillance system.

7. The remote surveillance system of claim 5 wherein the activation switch is in communication with the CPU; the CPU orders the activation switch to place system in sleep mode to conserve energy.

8. The remote surveillance system of claim 6 wherein the CPU is enabled for analyzing sounds; the sonar analysis distinguishes between various sound signatures.

9. The remote surveillance system of claim 7 further comprising a database, the database storing a plurality of sound signatures for the purpose of identifying sounds from an object.

10. The remote surveillance system of claim 9 further comprising a laser system; the laser system for use in directing a laser on targets for the purpose of directing smart ordnance.

11. The remote surveillance system of claim 10 wherein the housing is shaped and colored to be camouflaged.

12. A remote surveillance system used for monitoring movements and sounds; the remote surveillance system is operated from a distance comprising: a power system, a video system, an audio system, at least one satellite, a CPU, a communications system, and a housing; the power system comprising at least one solar collector and at least one battery, the solar collector is in communication with a battery, the video system comprises at least one camera; the communications system comprises a cell transmitter, a cell receiver, the communications system is in communication with the audio and video systems; the audio system comprises at least one microphone, the microphone(s) are located on top of the housing; the satellite is comprised of a communications system.

13. The remote surveillance system wherein the satellite further comprises a location device, the location means is used to enable the system to locate the satellite.

14. The remote surveillance system of claim 14 wherein the location device is a GPS device.

15. The remote surveillance system of claim 15 wherein the satellite is motion-activated.

16. The remote surveillance system of claim 16 wherein the satellite is sound activated.

17. The remote surveillance system of claim 17 wherein the database further comprises a target signature, the target signature is used for the purpose of activating the system from a dormant state to an active state.

18. The remote surveillance system of claim 18 wherein the housing is comprised of a composite polycarbonate material.

19. The remote surveillance system of claim 19 further comprising a cooling system, the cooling system is used to prevent the system from overheating.

20. A remote surveillance system used for monitoring movements and sounds; the remote surveillance system is operated from a distance comprising: a power system, a GPS device, a video system, an audio system, a CPU, a communications system, and a housing; the power system comprising at least one solar collector and at least one battery, the solar collector is in communication with a battery, the video system at least one infrared camera, at least one wide lens camera, and at least one zoom enabled camera; the communications system comprises a cell transmitter, a cell receiver, the communications system is in communication with the audio and video systems; the audio system comprises at least three microphones, the microphones are located on top of the housing, the microphones are positioned substantially equidistantly from each other for the purpose of triangulating the position of sounds.
